(19) United States
(12) Patent Application Publication
(10) Pub. No.: US 2003/0106884 A1
(43) Pub. Date: Jun. 12, 2003

(54) Electrical heating device with low electromagnetic wave effect

(76) Inventor: Meng Hua Yu, Taipei (TW)

Correspondence Address: Bruce H. Troxell, SUITE 1404, 5205 LEESBURG PIKE, FALLS CHURCH, VA, 22041, US

(21) Appl. No.: 10/012,320

(22) Filed: Dec. 12, 2001

(51) Int. Cl. H05B 3/34

(52) U.S. Cl. 219/212; 219/528; 219/538

(57) ABSTRACT

An electrical heating device of low electromagnetic wave effect comprises a power wire connected to a power source and a corresponding heating wire connected in series to the power wire. Said heating wire and said power wire each have two ends, one of the ends of said heating wire and one of the ends of said power wire being connected in series and the other one of the ends of said heating wire and the other one of the ends of said power wire being connected to said same power source, and said heating wire and said power wire being in spaced arrangement at a predetermined distance. The electrical heating device further comprises an insulator for providing a common spaced arrangement of the heating wire and the power wire inside the insulator. According to such structure, the present invention can effectively offset the electromagnetic wave and thereby lower the overall electromagnetic wave effect.

### BACKGROUND OF THE INVENTION

1. Field of the Invention

The present invention relates to an electrical heating device of low electromagnetic wave effect, in particular to an electrical heating device of low electromagnetic wave effect which is capable of effectively reducing the electromagnetic wave effect and has a simple construction.

2. Description of the Related Art

Flat-type electrical heating devices such as utilized in electric blankets are often used for providing warmth to the human body and even so far as for therapy of diseases. However, the electrical current passing through the heating elements therein will form into electromagnetic field which in turn emits electromagnetic wave radiation. According to medical researches, electromagnetic wave might give rise to a number of diseases to the human body. Therefore, many countries establish related rules and regulations in regard to electromagnetic wave-emitting products for restriction and management thereof.

As shown in FIG. 1, an electrical heating device of low electromagnetic wave effect currently existing in the art includes an upper input end 81 and a lower input end 83 which are of opposite current directions and which are spaced apart from one another according to a predetermined distance by an insulator 89. The upper input end 81 has an upper input lead wire 811 while the lower input end 83 has a lower input lead wire 813. The upper input end 81 and lower input end 83 are isolated in arrangement on the upper surface and lower surface of the insulator 89, respectively. Furthermore, a first heat-generating lead wire 85 is positioned on the first plane and connected to the upper input end 81 according to a predetermined distance, and has current flow direction the same as that of the upper input end 81. The electrical heating device further includes a second heat-generating lead wire 87 located on a second plane which is parallel to-the first plane. The second heat-generating lead wire 87 and the first heat-generating lead wire 85 form a specific distance and connect the lower input end 83. Moreover, the current direction of the second heat-generating lead wire 87 is opposite to that of the first heat-generating lead wire 85. When electricity is on, the current flows through the upper input lead wire 811 to the first heat-generating lead wire 85, and through the lower input lead wire 813 to the second heat-generating lead wire 87, causing the first and second heat-generating lead wires 85,87 to heat up and produce a heating effect. In addition, the upper input lead wire 811 and the lower input lead wire 813 in spaced-apart arrangement therefrom are of opposite current directions, as are the first heat-generating lead wire 85 and the second heat-emitting lead 87 in spaced-apart arrangement therefrom, and can offset some of the electromagnetic field originally possessed by each, thereby reducing the amount of electromagnetic radiation generated by the device.

While such device can decrease the amount of electromagnetic radiation, the input lead wires and the heat-generating lead wires are divided into the upper and lower layers, and has the defect of complicated circuitry. Furthermore, due to the presence of an insulator, the overall thickness of the electrically heated article or product into which this device is incorporated is increased. This device is not applicable where a thinner article or product is required. Besides, the presence of the insulator 89 might increase the distance between the upper and lower input lead wires 811,813 and the distance between the first and second heat-generating lead wires 85,87, thereby decreasing the effect of offsetting the electromagnetic field.

### SUMMARY OF THE INVENTION

Accordingly, an object of the present invention is to provide an electrical heating device of a low electromagnetic wave effect which is capable of effectively lowering the electromagnetic wave effect.

A further object of the present invention is to provide an electrical heating device of a low electromagnetic wave effect which is of a simple construction and does not increase the thickness or size of the electrically heated article or product into which the device is incorporated.

To realize the above objects, the present invention provides an electrical heating device of low electromagnetic wave effect which comprises a power wire connected to a power source and a corresponding heating wire connected in series to the power wire. Said heating wire and said power wire each have two ends, one of the ends of said heating wire and one of the ends of said power wire being connected in series and the other one of the ends of said heating wire and the other one of the ends of said power wire being connected to said same power source, and said heating wire and said power wire being in spaced arrangement at a predetermined distance. The electrical heating device further comprises an insulator for providing a common spaced arrangement of the heating wire and the power wire inside the insulator.

According to such structure, the present invention can effectively offset the electromagnetic wave and thereby lower the overall electromagnetic wave effect. Furthermore, it is not necessary to install complicated and multi-layer wiring, and thus, the thickness or size of the electrically heated article or product into which the device is mounted will not be increased.

### BRIEF DESCRIPTION OF THE DRAWINGS

Other features and advantages of the present invention will become apparent in the following detailed description of a preferred embodiment of the present invention with reference to the accompanying drawings, in which:

FIG. 1 is a plan view of the state-of-the-art heating device which can lower electromagnetic wave;

FIG. 2 is a schematic diagram of the circuitry of a preferred embodiment of the present invention;

FIG. 3 is a perspective view of the preferred embodiment as applied to an electric blanket; and

FIG. 4 is a perspective sectional view of the insulator shown in FIG. 3.

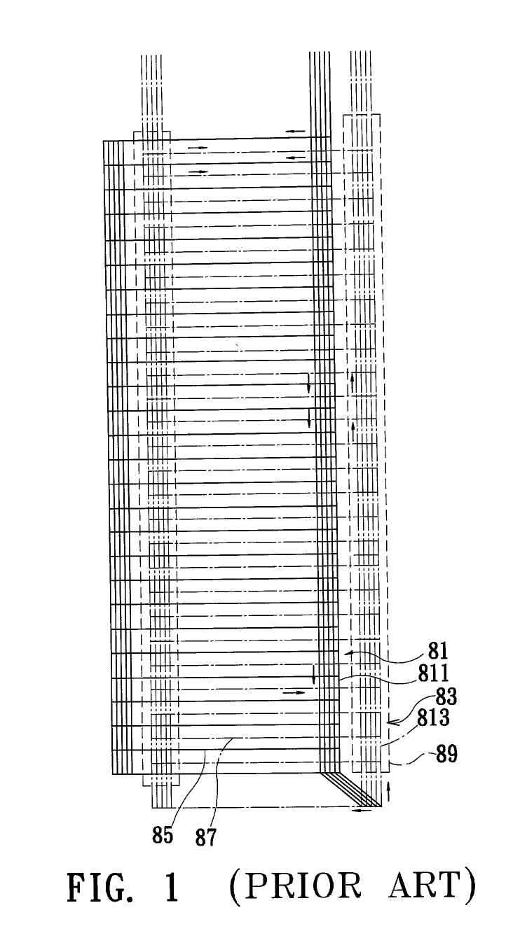

### DETAILED DESCRIPTION OF THE PREFERRED EMBODIMENT

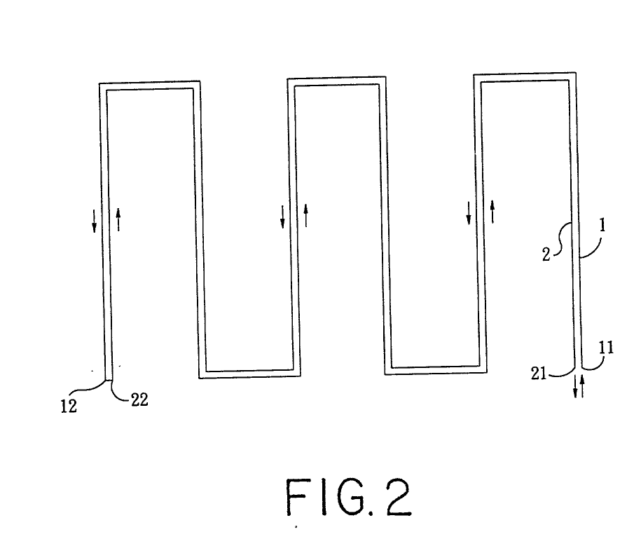

As shown in FIG. 2, an electrical heating device of low electromagnetic wave effect according to a preferred embodiment of the present invention is formed of a current-transmitting power wire 1 and a heating wire 2 connected in series thereto, the heating wire 2 being in a parallel, spaced-apart arrangement to the power wire 1 and capable of generating heat after being powered by electricity. The power wire 1 and the heating wire 2 are preferably of the same length and positioned in the same plane, and each have a first power supply end 11 and a second power supply end 21 both connected to a common power source (not shown), and a first connecting end 12 and a second connecting end 22 connected in series to each other, respectively, whereby, a closed loop for the flow of current is formed among the power source, power wire 1 and heating wire 2. Since the power wire 1 and heating wire 2 can be parallely disposed at a very small spacing therebetween, and the flow direction of the current inside the two is opposite, most of the electromagnetic wave emitted by each is offset, and thus the overall electromagnetic wave effect is lowered.

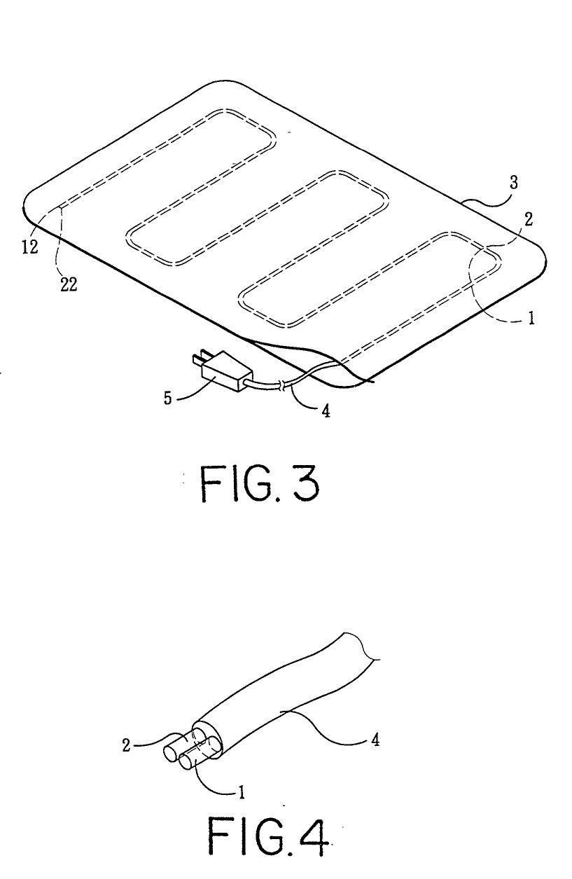

Referring to FIGS. 3 and 4, a preferred embodiment of the application of the present invention to a small-type electric blanket 3 is shown. In this embodiment, the power wire 1 and heating wire 2 are disposed in entirety in the insulator 4 of elongated cable shape, the power wire 1 and the heating wire 2 being arranged in parallel at a very small spacing therebetween and being isolated and insulated by the insulator 4 placed therebetween. The insulator 4 extends in a tortuous manner inside the plane of the electric blanket 3, the terminal end thereof being positioned at the first connecting end 12 of the power wire 1 and the second connecting end 22 of the heating wire 2, and the other end opposite to the terminal end projecting out of the electric blanket 3 and being connected to a plug 5. By the electrical connection of the plug 5 inserted into the socket of an external power source (not shown), electrical current is provided which, as stated above, flows through the socket, the power wire 1 and the heating wire 2, causing the heating wire 2 to generate heat energy which is transmitted to the entire body of the electric blanket 3. At the same time, since the power wire 1 and the heating wire 2 are isolated by the very thin insulator 4 therebetween and are in parallel arrangement, the electromagnetic wave produced by each can mostly be offset, thereby lowering the electromagnetic wave effect of the overall electric blanket 3 as much as possible.

By means of the above-described device, the present invention not only can effectively offset the inherent electromagnetic wave to thereby decrease as much as possible the overall electromagnetic wave effect due to the power wire 1 and heating wire 2 being arranged at a very small spacing therebetween, but also does not require a complicated or a multi-layer circuitry due to the principle employed therein of making the direction of current of the power wire 1 opposite to that of the heating wire 2, and thus, the thickness or size of the electrically heated article or product to which the present invention may be applied, such as the electric blanket 3, will not and need not be increased.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modification's and equivalent arrangements.

What is claimed is:

1. An electrical heating device of low electromagnetic wave effect, comprising a power wire connected to a power source and a corresponding heating wire connected to said power wire, characterized in that said heating wire and said power wire each have two ends, one of the ends of said heating wire and one of the ends of said power wire being connected in series and the other one of the ends of said heating wire and the other one of the ends of said power wire being connected to said same power source, and said heating wire and said power wire being in spaced arrangement at a predetermined distance.

2. An electrical heating device of low electromagnetic wave effect according to claim 1, characterized in that said heating wire and said power wire are of the same length.

3. An electrical heating device of low electromagnetic wave effect according to claim 1, characterized in that said heating wire is in parallel arrangement relative to said power wire.

4. An electrical heating device of low electromagnetic wave effect according to claim 1, characterized in that said heating wire and said power wire are positioned in the same plane.

5. An electrical heating device of low electromagnetic wave effect according to claim 1, characterized in that said electrical heating device further comprises an insulator for providing a common spaced arrangement of said heating wire and said power wire inside said insulator.

6. An electrical heating device of low electromagnetic wave effect according to claim 5, characterized in that said insulator is of an elongated cable shape.
